(19) United States
(12) Patent Application Publication
(10) Pub. No.: US 2026/0115847 A1
(43) Pub. Date: Apr. 30, 2026

(54) HORIZONTAL MACHINE TOOL

(71) Applicant: SUGINO MACHINE LIMITED, Namerikawa City (JP)

(72) Inventors: Ryo EGAWA, Namerikawa City (JP); Yasuhiro TOMINAGA, Namerikawa City (JP); Shun HAYAKAWA, Namerikawa City (JP); Takuya MORIGUCHI, Namerikawa City (JP)

(21) Appl. No.: 19/368,152

(22) Filed: Oct. 24, 2025

(30) Foreign Application Priority Data
Oct. 25, 2024 (JP) 2024-188611
Oct. 25, 2024 (JP) 2024-188620

(51) Int. Cl. B23Q 1/70; B23Q 1/01; B23Q 1/54

(52) U.S. Cl. CPC B23Q 1/706; B23Q 1/015; B23Q 1/54

(57) ABSTRACT

Provided is a horizontal machine tool including a trunnion table and capable of being divided. The horizontal machine tool includes: a main frame; a spindle moving device disposed on the main frame; a spindle head supported by the spindle moving device in a movable manner in an X-axis direction, a Y-axis direction and a Z-axis direction, the spindle head having a spindle extending horizontally; a front frame disposed in front of the main frame; a trunnion table disposed on the front frame in a movable manner in a W-axis direction parallel to the Z-axis direction, the trunnion table rotatable about an A-axis parallel to the X-axis direction; and a connection block connecting the main frame and the front frame.

### CROSS-REFERENCE TO RELATED APPLICATIONS

This application claims the benefit of priority to Japanese Patent Application No. 2024-188611, filed on Oct. 25, 2024, and Japanese Patent Application No. 2024-188620, filed on Oct. 25, 2024, the entire contents of which are hereby incorporated by reference.

### BACKGROUND

### 1. Technical Field

The present invention relates to a horizontal machine tool.

### 2. Description of the Background

A horizontal machine tool including an X-axis guide rail, a column, a Y-axis guide rail, a saddle, a Z-axis guide rail, and a spindle head is known (for example, Japanese Patent No. 4514310). The X-axis guide rail is disposed on an upper surface of a bed. The column, which is mounted on the X-axis guide rail, is movable in an X direction. The Y-axis guide rail is disposed on one side surface of the column. The saddle, which is supported by the Y-axis guide rail, is movable in a Y direction. The Z-axis guide rail is disposed on the saddle. The spindle head is supported in a horizontal posture by the Z-axis guide rail.

### BRIEF SUMMARY

When a large workpiece is machined, a size of a machine becomes large. However, for convenience in transportation of the machine, it is preferable to provide a machine that can be divided. The conventional horizontal machine tool makes no reference to a divided structure.

An object of the present invention is to provide a horizontal machine tool including a trunnion table and capable of being divided.

A first aspect of the present invention provides a horizontal machine tool, including:
a main frame;
a spindle moving device disposed on the main frame;
a spindle head supported by the spindle moving device in a movable manner in an X-axis direction, a Y-axis direction and a Z-axis direction, the spindle head having a spindle extending horizontally;
a front frame disposed in front of the main frame;
a trunnion table disposed on the front frame in a movable manner in a W-axis direction parallel to the Z-axis direction, the trunnion table rotatable about an A-axis parallel to the X-axis direction; and
a connection block connecting the main frame and the front frame.

The front frame may be disposed apart from the main frame.

The horizontal machine tool may include an inclined plate disposed between a pair of box-shaped pedestals and having a discharge port at a center in a left-right direction.

The trunnion table may include a turntable rotatable about a B-axis orthogonal to the A-axis.

The trunnion table may include a pair of side plates rotatable about the A-axis, and a base plate connecting lower portions of the pair of side plates. The turntable may be disposed at a center of the base plate.

A sum (sum of stroke) of a moving distance of the spindle head in the Z-axis direction and a moving distance of the trunnion table in the W-axis direction may be about 1000 to 2000 mm.

The horizontal machine tool may be capable of cutting a three-dimensional large workpiece having a size of about 1000 to 2000 mm on a side.

The horizontal machine tool may include a connection block connecting the main frame and the front frame. The horizontal machine tool may include a pair of the connection blocks. The pair of connection blocks may be disposed at intervals in the X-axis direction. Preferably, the pair of connection blocks are disposed at left and right ends (both ends in the X-axis direction) of the horizontal machine tool.

The front frame may include a pair of box-shaped pedestals disposed at left and right ends and standing independently on a floor surface, and a bridge portion connecting between the pair of box-shaped pedestals. A first W-axis guide may be disposed on one of the pair of box-shaped pedestals. A second W-axis guide may be disposed on the other of the pair of box-shaped pedestals. A first driving unit may be disposed on one of the pair of box-shaped pedestals. A second driving unit may be disposed on the other of the pair of box-shaped pedestals. The first and second driving units move the first and second rotary tables in the Z-axis direction, respectively.

The inclined plate may be supported by the front frame. The inclined plate may be supported by the pair of box-shaped pedestals.

According to the present invention, a horizontal machine tool including the trunnion table and capable of being divided can be provided.

### BRIEF DESCRIPTION OF DRAWINGS

FIG. 1 is a perspective view of a horizontal machine tool according to an embodiment.

FIG. 2 is a view taken along an arrow II in FIG. 1.

FIG. 3 is a sectional view taken along line III-III in FIG. 2.

FIG. 4 is a sectional view taken along line IV-IV in FIG. 2.

FIG. 5 is a sectional view taken along line V-V in FIG. 4.

FIG. 6 is a sectional view taken along line VI-VI in FIG. 4.

FIG. 7 is a sectional view taken along line VII-VII in FIG. 2.

FIG. 8 is an exploded assembly view of a connection block.

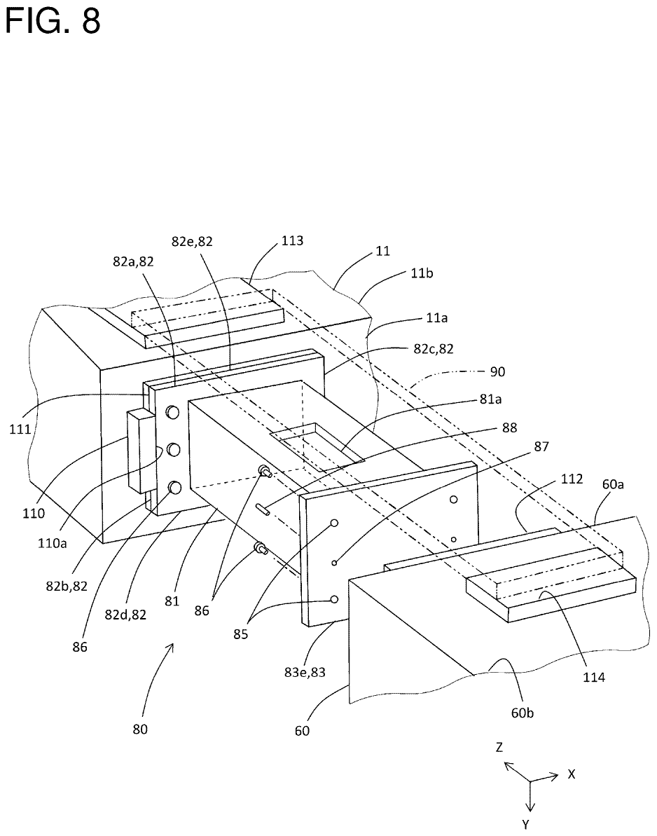

FIG. 9 is a flowchart showing an assembly procedure.

### DETAILED DESCRIPTION

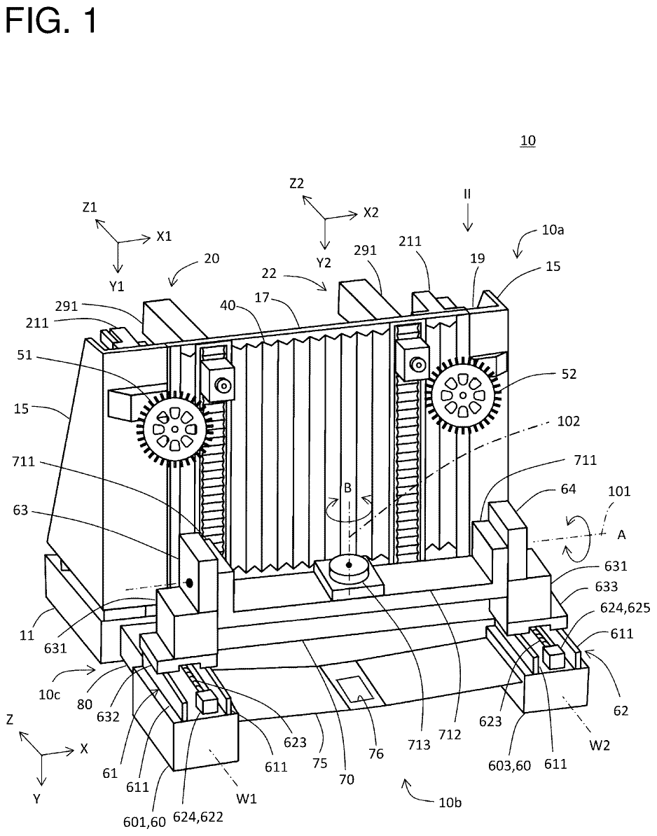

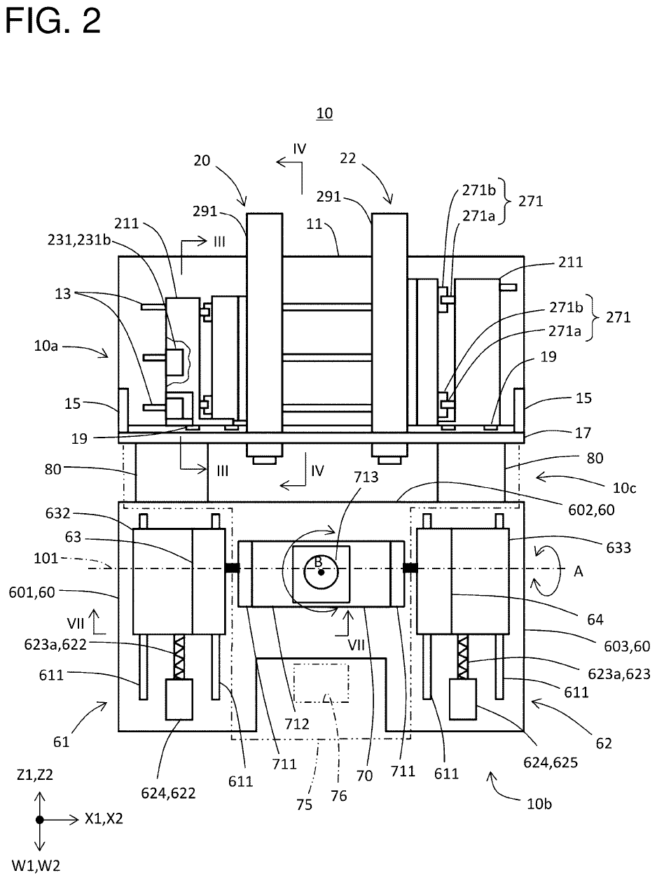

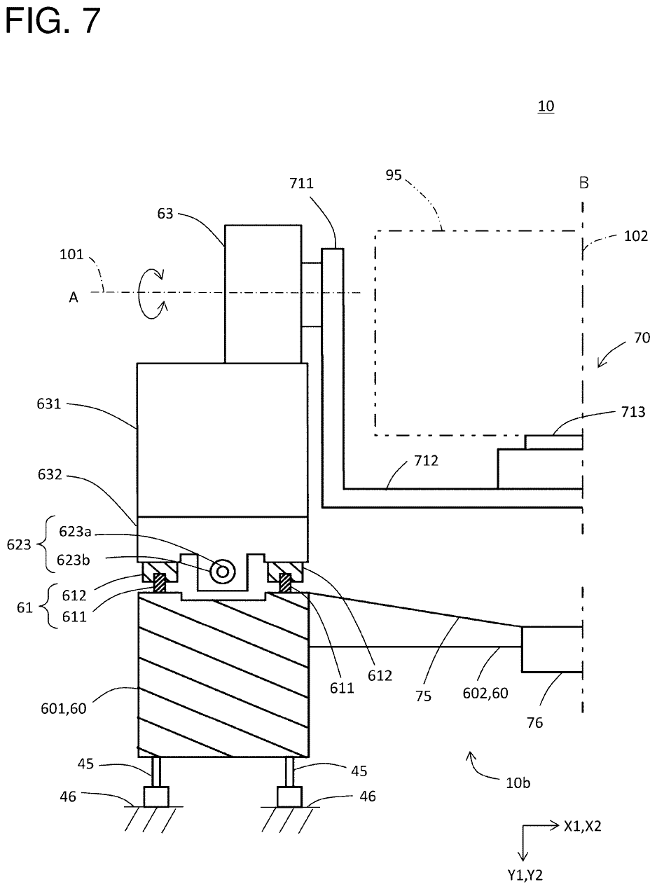

As shown in FIGS. 1 and 2, a horizontal machine tool (horizontal machining tool) 10 according to the embodiment includes a machining section 10a, a workpiece holding section 10b, and a connecting section 10c. The machining section 10a machines a workpiece 95 (see FIG. 7). The workpiece holding section 10b holds the workpiece 95 in a predetermined posture. The connecting section 10c detachably connects the machining section 10a and the workpiece holding section 10b.

As shown in FIGS. 1 to 6, the machining section 10a includes a main frame (frame) 11, a pair of lower X-axis guides 13, a pair of fixed columns 15, an upper beam 17, an upper X-axis guide 19, processing units 20 and 22, a bellows cover (expandable cover) 40, and automatic tool changers (ATC) 51 and 52.

For convenience of description, X, Y, and Z axes are defined as illustrated. A left-right direction is defined as an X direction (X1, X2 directions), an up-down direction is defined as a Y direction (Y1, Y2 directions), and a front-rear direction is defined as a Z direction (Z1, Z2 directions). In FIG. 1, an A-axis extends in the X direction. A B-axis extends in the Y direction. W1-axis and W2-axis extend in the Z direction.

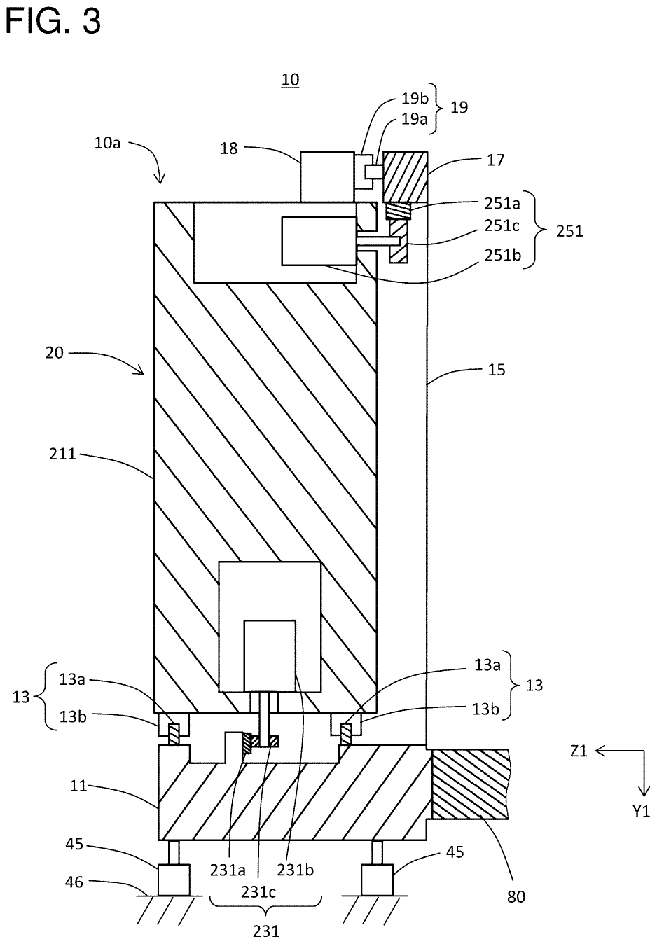

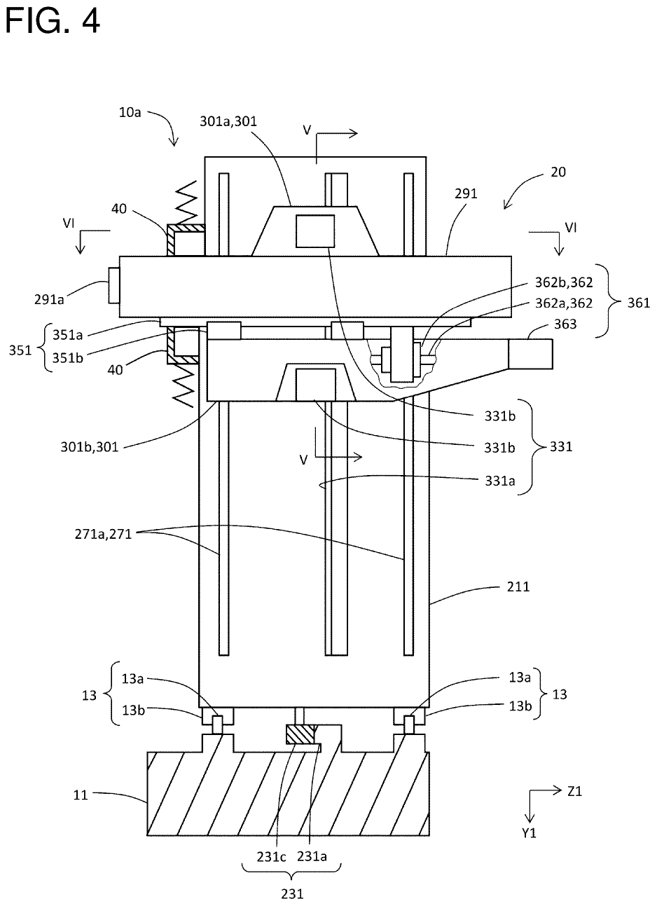

For convenience, FIGS. 3 and 4 show an arrangement rotated by 90 degrees. In the following description, unless it is necessary to distinguish between the X1 direction and the X2 direction, they are collectively referred to as the X direction. Similarly, Y1 and Y2 directions may be collectively referred to as the Y direction, and Z1 and Z2 directions may be collectively referred to as the Z direction. A direction along the W1-axis and W2-axis may be referred to as a W direction.

As shown in FIG. 3, the lower X-axis guide 13 includes a lower X-axis guide rail 13a and a lower X-axis guide block 13b. The lower X-axis guide rail 13a, which extends in the X direction, is fixed to an upper surface of the main frame 11. The lower X-axis guide block 13b, which is disposed on the lower X-axis guide rail 13a, moves in the X direction along the lower X-axis guide rail 13a.

As shown in FIG. 1, the pair of fixed columns 15 are disposed at both ends of the main frame 11 in the X direction. The upper beam 17 is bridged between upper ends of the pair of fixed columns 15. The upper beam 17 extends in the X direction.

As shown in FIG. 3, the upper X-axis guide 19 includes an upper X-axis guide rail 19a and an upper X-axis guide block 19b. The upper X-axis guide rail 19a, which extends in the X direction, is fixed to a rear surface of the upper beam 17. The upper X-axis guide block 19b, which is disposed on the upper X-axis guide rail 19a, moves in the X direction along the upper X-axis guide rail 19a.

As shown in FIGS. 3 to 6, the processing unit 20 includes a moving column 211, a lower X-axis driving device 231, an upper X-axis driving device 251, a Y-axis guide 271, a Y-base 301, a Y-axis driving device 331, a Z-axis guide 351, a spindle head 291, a spindle 291a, and a Z-axis driving device 361.

The processing unit 22 and the processing unit 20 are arranged symmetrically with respect to a YZ plane. The processing unit 22 has substantially the same configuration as the processing unit 20. Accordingly, description will be given of the processing unit 20, and detailed description of the processing unit 22 is omitted.

As shown in FIG. 3, the moving column 211 includes a bracket 18 on an upper surface. The moving column 211 extends in the Y direction. The moving column 211 has a lower portion fastened to the lower X-axis guide block 13b. The bracket 18 is fastened to a rear surface of the upper X-axis guide block 19b. The moving column 211 is guided by the lower X-axis guide 13 and the upper X-axis guide 19 to reciprocate in the X direction. The moving column 211 supports the spindle head 291.

The lower X-axis driving device 231 is disposed at a lower portion of the moving column 211. The lower X-axis driving device 231 includes a lower X helical rack 231a, a lower X motor 231b, and a lower X helical gear 231c. The lower X helical rack 231a, which extends in the X direction, is fixed to the main frame 11. The lower X motor 231b is disposed at a lower end portion of the moving column 211. The lower X helical gear 231c, which is connected to the lower X motor 231b, meshes with the lower X helical rack 231a.

The upper X-axis driving device 251 is disposed above the moving column 211. The upper X-axis driving device 251 includes an upper X helical rack 251a, an upper X motor 251b, and an upper X helical gear 251c. The upper X helical rack 251a, which extends in the X direction, is fixed to a lower surface of the upper beam 17. The upper X motor 251b is fixed to an upper end portion of the moving column 211. The upper X motor 251b rotates in synchronization with the lower X motor 231b. The upper X helical gear 251c, which is connected to the upper X motor 251b, meshes with the upper X helical rack 251a.

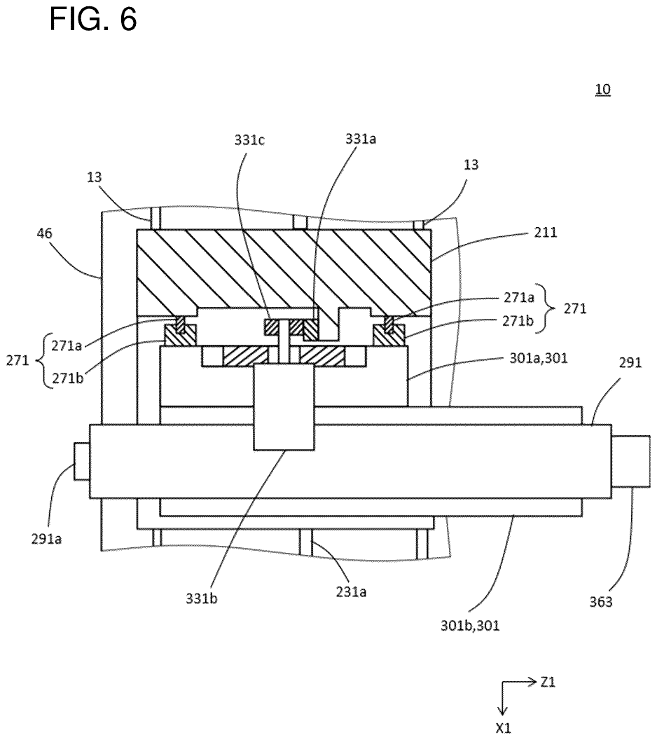

As shown in FIGS. 4 and 6, the Y-axis guide 271 includes a pair of Y guide rails 271a and a plurality of Y guide blocks 271b. The Y guide rail 271a, which extends in the Y direction, is disposed on one side surface (closer to the center of the horizontal machine tool 10) of the moving column 211. The Y guide block 271b, which is disposed on the Y guide rail 271a, moves in the Y direction along the Y guide rail 271a.

The Y-base 301 is L-shaped as viewed from the front. The Y-base 301 includes a plate portion 301a and a box portion 301b. The plate portion 301a extends in the YZ direction. The plate portion 301a fastens the Y guide block 271b. The box portion 301b, which is box-shaped with an opening at an upper side, extends in the Z direction. The Y-base 301 is guided by the Y-axis guide 271 to reciprocate in the Y direction.

As shown in FIGS. 4 to 6, the Y-axis driving device 331 includes a Y helical rack 331a, a pair of Y motors 331b, and a Y helical gear 331c. The Y helical rack 331a, which extends in the Y direction, is disposed on the moving column 211.

The pair of Y motors 331b are fastened to upper and lower end portions of the Y-base 301. The Y helical gear 331c, which is connected to each Y motor 331b, meshes with the Y helical rack 331a. The pair of Y motors 331b rotate in synchronization to feed the Y-base 301 in the Y direction.

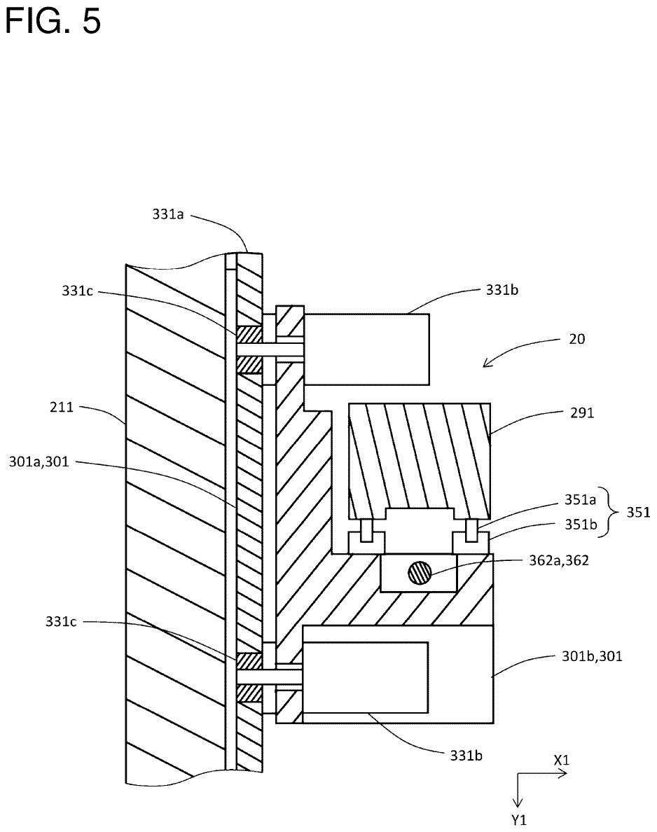

As shown in FIG. 5, the pair of Z-axis guides 351 includes a Z guide rail 351a and a Z guide block 351b. The Z guide block 351b, which is disposed on an upper surface of the box portion 301b, extends in the Z direction. The Z guide rail 351a, which extends in the Z direction, is disposed on the Z guide block 351b. The Z guide rail 351a reciprocates in the Z direction on the Z guide block 351b.

The spindle head 291, which has a rectangular cross-section, extends in the Z direction. As shown in FIG. 4, the spindle head 291 is disposed above the box portion 301b. The spindle head 291 projects forward of the bellows cover 40. The spindle head 291 is fastened to the Z guide rail 351a. The spindle head 291 is guided by the Z-axis guide 351 to advance and retract in the Z direction. The spindle 291a is supported at a distal end of the spindle head 291. A tool stored in the ATCs 51 and 52 is detachably attached to the spindle 291a. The tool rotates integrally with the spindle 291a to cut the workpiece 95.

As shown in FIG. 4, the Z-axis driving device 361 includes a feed screw 362 and a Z motor 363. The feed screw 362 includes a screw shaft 362a and a nut 362b. The screw shaft 362a is rotatably disposed inside the box portion 301b. The nut 362b is fastened to the spindle head 291. The Z motor 363, which is disposed at a rear end of the box portion 301b, is connected to the screw shaft 362a. The Z-axis driving device 361 drives the spindle head 291 in the Z direction.

Next, the workpiece holding section 10b will be described. As shown in FIGS. 1, 2, and 7, the workpiece holding section 10b includes a front frame (frame) 60, a pair of W-axis guides 61 and 62, a block 631, W-axis driving devices (first driving unit and second driving unit) 622 and 625, W-bases (moving tables) 632 and 633, a pair of A-axis rotary tables 63 and 64, a trunnion table 70, and an inclined plate 75. The workpiece holding section 10b is symmetrical with respect to a YZ plane passing through a center axis B of a turntable 713. FIG. 7 shows only a left half of the workpiece holding section 10b. For convenience, in FIG. 2, the inclined plate 75 is indicated by a two-dot chain line.

The front frame 60 serves as a base of the workpiece holding section 10b. The front frame 60 supports the W-axis guides 61 and 62, the A-axis rotary tables 63 and 64, the trunnion table 70, the block 631, the W-bases 632 and 633, the inclined plate 75, and the W-axis driving devices 622 and 625.

The front frame 60 includes a pair of W-frames (box-shaped pedestals) 601 and a bridge portion 602 (see FIG. 7). Each W-frame 601 is a box-shaped pedestal. The W-frame 601 is supported from a floor surface 46 by, for example, jacks 45. Each jack 45 is, for example, a jack bolt. The bridge portion 602 is suspended between the pair of W-frames 601 to connect rear end portions the bridge portion 602. The bridge portion 602 opens a space in front of and below the trunnion table 70.

Gravity of all structures 61 to 64, 70, 75, 631 to 633, 622, and 625 supported by the bridge portion 602 and the front frame 60 and gravity of the workpiece 95 act on the pair of W-frames 601. The W-frames 601 have sufficient strength to support these weights.

Each W-axis guide 61 includes a pair of W guide rails 611 and a pair of W guide blocks 612. The W guide rail 611 each, which extends in the W direction, is disposed on an upper surface of the W-frame 601. The W guide block 612 each, which is disposed on the W guide rail 611, reciprocates on the W guide rail 611. The W-axis guide 62 is substantially the same as the W-axis guide 61.

The W-base 632 is fastened to the W guide block 612. The W-base 632 is guided by the W-axis guide 61 to reciprocate in the W direction. The W-base 633 is substantially the same as the W-base 632.

The W-axis driving device 622 includes a feed screw 623. The feed screw 623 includes a screw shaft 623a and a nut 623b. The screw shaft 623a, which extends along the W-axis, is rotatably supported by the W-frame 601. The nut 623b is fastened to the W-base 632. The W-axis driving device 622 further includes a motor 624. The motor 624 is connected to the screw shaft 623a. The motor 624 feeds the W-base 632 in the W-axis direction.

The W-axis driving device 625 is substantially the same as the W-axis driving device 622. The W-axis driving device 625 feeds the W-base 633 in the W-axis direction in synchronization with the W-axis driving device 622.

The A-axis rotary table 63 is fastened to the W-base 632 via the block 631. The A-axis rotary table 63 rotates about the A-axis 101. The A-axis 101 is parallel to the X-axis. The A-axis rotary table 64 rotates in synchronization with the A-axis rotary table 63.

The trunnion table 70 is disposed between the pair of A-axis rotary tables 63 and 64. The trunnion table 70 is tiltably supported about the A-axis 101 by the A-axis rotary tables 63 and 64. The trunnion table 70 includes a pair of side plates 711 and a base plate 712. The base plate 712 connects lower end portions of the pair of side plates 711. A turntable (B-axis rotary table) 713 is disposed on the base plate 712. The turntable 713 rotates about the B-axis 102. The B-axis 102 is orthogonal to the A-axis 101. The B-axis 102 is parallel to the Y-axis.

When the W-axis driving devices 622 and 625 are driven and the W-bases 632 and 633 move in the W-axis direction, the A-axis rotary tables 63 and 64 attached to the W-bases 632 and 633 and the trunnion table 70 move in the W-axis direction. When the A-axis rotary tables 63 and 64 rotate, the trunnion table 70 tilts about the A-axis 101. When the turntable 713 rotates, the workpiece 95 mounted on the turntable 713 rotates about the B-axis 102.

Accordingly, the workpiece 95 moves in the W-axis direction, rotates about the A-axis 101, and rotates about the B-axis 102. This allows the workpiece 95 to be changed to any posture. The workpiece 95 is, for example, approximately 1,500 mm×1,500 mm in size. For example, the workpiece 95 is a giga casting part for an automobile or an aircraft door frame.

The inclined plate 75 is disposed below the trunnion table 70. The inclined plate 75 is supported by the W-frame 601 and the bridge portion 602. The inclined plate 75 is in a tray shape inclined downward from both ends toward the center. The inclined plate 75 has a discharge port 76 in a central portion. The discharge port 76 is disposed in front of the bridge portion 602. The discharge port 76 is located between the W-frames 601 and 603. The inclined plate 75 collects coolant liquid and chips sprayed onto the workpiece 95 during machining, and discharges them through the discharge port 76.

The inclined plate 75 may extend between the front frame 60 and the main frame 11. A rear end portion of the inclined plate 75 may be supported by the main frame 11.

The connection block 80 connects the machining section 10a and the workpiece holding section 10b. A pair of connection blocks 80 are disposed on left and right sides. The connection block 80 includes a body portion 81, a flange portion 82, and a flange portion 83. The body portion 81 is in the shape of a square pipe. The body portion 81 may have a horizontal reference surface 81a on an upper surface thereof. The horizontal reference surface 81a may be a bottom surface of a recess formed on the upper surface of the body portion 81.

The flange portion 82, which is in the form of a rectangular plate, is disposed at end face of the body portion 81. The flange portion 82 includes a plurality of bolt holes 85, an upper surface 82a, an abutting surface 82b, and an end surface 82e. The upper surface 82a is parallel to a ZX plane. The abutting surface 82b, which is disposed near left and right ends of the main frame 11, is parallel to a YZ plane. The end surface 82e is parallel to an XY plane. The horizontal reference surface 81a, the abutting surface 82b, and the end surface 82e are machined to be predetermined finished surfaces. The horizontal reference surface 81a and the abutting surface 82b are reference surfaces for alignment.

The flange portion 83 includes bolt holes 85, pin holes 87, and an end surface 83e. The end surface 83e is substantially the same as the end surface 82e. The pin holes 87 are disposed at precise positions relative to the abutting surface 82b and the horizontal reference surface 81a.

The front frame 60 includes a rear surface 60a. The rear surface 60a faces the main frame 11. The rear surface 60a includes a reference surface 112. The reference surface 112 is machined to be a predetermined finished surface. The reference surface 112 has screw holes (not shown) and pin holes (not shown). The connection block 80 is fixed to the reference surface 112 with pins 88 and bolts 86. The connection block 80 is positioned in XY directions relative to the reference surface 112 by the pins 88. Further, the connection block 80 is precisely positioned in the Z direction by the end surface 83e abutting against the reference surface 112.

The main frame 11 includes a front surface 11a. The front surface 11a faces the front frame 60. The front surface 11a includes a reference block 110 and a reference surface 111. The reference block 110 is disposed adjacent to the reference surface 111. The reference block 110 includes a reference side surface 110a. The reference side surface 110a and the reference surface 111 are machined to be predetermined finished surfaces. The reference surface 111 has screw holes (not shown). Accordingly, when the end surface 82e abuts the reference surface 111 and the abutting surface 82b of the flange portion 82 abuts the reference side surface 110a of the reference block 110, the main frame 11 and the front frame 60 are positioned in a left-right direction (X direction) and a front-rear direction (Z direction).

The main frame 11 includes a reference plate 113 on an upper surface 11b. The front frame 60 includes a reference plate 114 on an upper surface 60b. An installation plate 90 is disposed so as to bridge between the reference plates 113 and 114. As will be described later, the installation plate 90 adjusts a height position between the main frame 11 and the front frame 60.

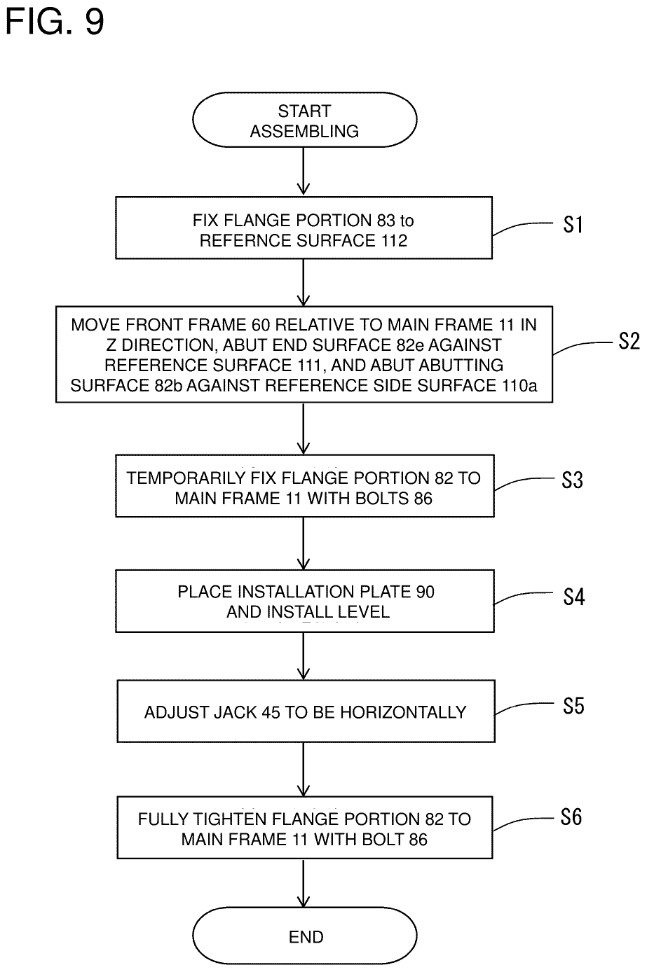

Next, a method for connecting the machining section 10a and the workpiece holding section 10b will be described. As shown in FIG. 9, the operator fixes the flange portion 83 to the reference surface 112 (Step S1). The flange portion 83 is precisely fixed to the reference surface 112 by the pins 88. Next, the operator moves the front frame 60 relative to the main frame 11 in the Z direction to bring the end surface 82e into abutment with the reference surface 111 and bring the abutting surface 82b into abutment with the reference side surface 110a (Step S2). Next, the operator temporarily fixes the flange portion 82 to the reference surface 111 with bolts 86 (Step S3).

By abutting the end surface 82e of the flange portion 82 against the reference surface 111 and abutting the end surface 83e of the flange portion 83 against the reference surface 112, the main frame 11 and the front frame 60 are positioned in the front-rear direction (Z direction). The abutting surface 82b of the flange portion 82 abuts the reference side surface 110a of the reference block 110, and the abutting surface 83b of the flange portion 83 abuts a side surface of a reference block (not shown). This positions the main frame 11 and the front frame 60 in the left-right direction (Y direction).

Next, the operator places the installation plate 90 between the reference plates 113 and 114 and installs a level (not shown) on the installation plate 90 (Step S4). Next, the operator adjusts the jacks 45 disposed at bottom portions of the main frame 11 and the front frame 60 while observing the level (Step S5). Height adjustment is performed until a level of the main frame 11, the front frame 60, and the installation plate 90 falls within a reference value, and when the level falls within the reference value, the bolts 86 are fully tightened (Step S6).

Note that step S4 may be modified as follows. The operator installs a height-increasing block (not shown) on the horizontal reference surface 81a. When the main frame 11 and the front frame 60 are precisely positioned, a height of an upper surface of the height-increasing block coincides with heights of the reference plates 113 and 114. The operator installs the installation plate 90 between the upper surface of the height-increasing block and the reference plate 113.

The main frame 11 may include an upper reference block (not shown). In this case, the upper surface 82a of the flange portion 82 and a bottom surface of the upper reference block are machined to be predetermined finished surfaces. The upper surface 82a may abut the bottom surface of the upper reference block. The operator may adjust the main frame 11 and the front frame 60 with the jacks so that the horizontal reference surface 81a becomes horizontal.

The flange portion 83 and the reference surface 112 may be disposed on the main frame 11. In this case, the flange portion 82, the reference surface 111, and the reference block 110 may be disposed on the front frame 60. That is, the connection block 80 may be fixed with pin on the front frame 60 side. The connection block 80 may be fixed with pin on the main frame 11 side.

The horizontal machine tool 10 according to the present embodiment achieves the following advantageous effects. The horizontal machine tool 10 including the trunnion table 70 capable of mounting a large workpiece 95 can be provided.

After the workpiece 95 is mounted on the trunnion table 70, the workpiece 95 can be held in any posture by rotating about the A-axis 101 and the B-axis 102. Further, by moving the trunnion table 70 in the W-axis direction, the workpiece 95 can be moved to any position in the front-rear direction. The workpiece 95 thus can be held at a predetermined position in a predetermined posture. Then, by appropriately exchanging tools, the workpiece 95 can be machined. Particularly, the pair of W-axis guides 61 and 62, the trunnion table 70, and the turntable 713 can hold the workpiece 95 in any posture.

Weight of the B-axis, the trunnion table 70, and the workpiece 95 is applied to the A-axis rotary table 63. Loads of the A-axis rotary table 63, the block 631, and the W-base 632 are applied to the W-frame 601 through the W-axis guide 61. The W-frame 601 stands independently from the floor surface 46. The W-frame 603 and an upper structure thereof are the same as the W-frame 601 and an upper structure thereof.

The pair of W-axis guides 61 and the W-axis driving device 622 are disposed on the W-frame 601. The A-axis rotary table 63, which is guided independently by the W-axis guide 61 on the W-frame 601, is fed by the W-axis driving device 622. The A-axis rotary table 64, which is guided independently by the W-axis guide 62 on the W-frame 603, is fed by the W-axis driving device 625. Further, the trunnion table 70 is bridged between the A-axis rotary tables 63 and 64. The both ends of the trunnion table 70 are independently guided and driven, respectively.

Accordingly, even when the trunnion table 70 has an extremely long width (for example, 1000 mm to 2000 mm), left and right A-axes (rotational axes) 101 of the trunnion table 70 can be moved in parallel with the X-axis. Thus, rigidity of the trunnion table 70 can be suppressed to a minimum. This suppresses a mass of the large trunnion table 70. Further, inertia applied to the A-axis rotary tables 63 and 64 can be reduced. The workpiece holding section 10b can be made compact.

The left and right W-frames 601 stand independently. The bridge portion 602 thus only needs to connect the W-frames 601 and 603 to each other. This suppresses rigidity of the front frame 60 to a minimum. The front frame 60 can be made compact. Further, spaces in front of and below the bridge portion 602 can be opened. A coolant tank and a chip collector can thus be disposed in the spaces. The discharge port 76 can be disposed below the trunnion table 70.

The horizontal machine tool 10 including the trunnion table 70 can have a three-division structure, that is, the machining section 10a, the workpiece holding section 10b, and the connecting section 10c. This reduces an entire size of the machine tool, and enhances convenience in transportation.

As the horizontal machine tool 10 has the three-division structure, assembly work on site is easy. As the reference surfaces 111 and 112 are provided on the main frame 11 and the front frame 60, positioning in the front-rear direction is easy. By abutting the abutting surface 82b of the flange portion 82 against the reference side surface 110a of the reference block 110, the reference block 110 and the flange portion 82 can be easily positioned in the left-right direction. The flange portion 83 is substantially the same. By bridging the installation plate 90 between the reference plates 113 and 114 of the main frame 11 and the front frame 60, and installing the level on the installation plate 90, a levelness of the reference plate 114 relative to the reference plate 113 can be easily measured. Then, by jacking up based on the measurement result, the levelness can be easily adjusted. Accordingly, a state before shipment of the large horizontal machine tool 10 can be easily reproduced on site.

The present invention is not limited to the above-described embodiment and can be variously modified without departing from the gist of the present invention. All technical matters included in the technical idea described in the claims are included in the scope of the present invention. Although the above-described embodiment has been described as a preferable example, a person skilled in the art can realize various alternative examples, modifications, variations, or improvements based on the contents disclosed in this specification, and these are included in the technical scope described in the appended claims.

Matters described in Japanese Patent Application No. 2023-080267 can be referred to when implementing the machining section 10a. Further, matters described in Japanese Patent Application No. 2024-114635 can be referred to when implementing the ATCs 51 and 52. That is, Japanese Patent Application Nos. 2023-080267 and 2024-114635 are incorporated herein by reference.

### REFERENCE SIGNS LIST

10 Horizontal machine tool
11 Main frame
211 Moving column
291 Spindle head
291a Spindle
60 Front frame
61, 62 W-axis guide
63, 64 A-axis rotary table
70 Trunnion table
80 Connection block
101 A-axis

What is claimed is:

1. A horizontal machine tool, comprising:
a main frame;
a spindle moving device disposed on the main frame;
a spindle head supported by the spindle moving device in a movable manner in an X-axis direction, a Y-axis direction and a Z-axis direction, the spindle head having a spindle extending horizontally;
a front frame disposed in front of the main frame;
a trunnion table disposed on the front frame in a movable manner in a W-axis direction parallel to the Z-axis direction, the trunnion table rotatable about an A-axis parallel to the X-axis direction; and
a connection block connecting the main frame and the front frame.

2. The horizontal machine tool according to claim 1, wherein
the front frame includes
a pair of box-shaped pedestals disposed at left and right ends and standing independently on a floor surface, and
a bridge portion connecting between the pair of the box-shaped pedestals,
the horizontal machine tool further comprises:
a pair of W-axis guides disposed on the pair of the box-shaped pedestals respectively; and
a pair of rotary tables configured to reciprocate along the W-axis guide, the pair of rotary tables rotatable about the A-axis;
wherein
the trunnion table includes both ends supported by the pair of the rotary tables, the trunnion table configured to tilt about the A-axis.

3. The horizontal machine tool according to claim 2, wherein
the bridge portion connects rear end portions of the pair of the box-shaped pedestals to open a space below the trunnion table.

4. The horizontal machine tool according to claim 2, further comprising:
an inclined plate disposed between the pair of the box-shaped pedestals, the inclined plate having a discharge port at a center in a left-right direction.

5. The horizontal machine tool according to claim 1, further comprising:
a pair of the connection blocks;
wherein the pair of the connection blocks are disposed on the main frame at a predetermined interval in the X-axis direction.

6. The horizontal machine tool according to claim 1, wherein
the connection block includes
a body portion,
a first flange portion disposed on a first end side of the body portion to be connected to the main frame, and
a second flange portion disposed on a second end side of the body portion to be connected to the front frame, and
the first flange portion and the second flange portion each have a flat end surface.

7. The horizontal machine tool according to claim 6, wherein
the main frame includes a flat first reference surface on which the first flange portion is mounted,
the front frame includes a flat second reference surface on which the second flange portion is mounted, and
the front frame is positioned relative to the main frame in the Z-axis direction by abutting the end surface of the first flange portion against the first reference surface and abutting the end surface of the second flange portion against the second reference surface.

8. The horizontal machine tool according to claim 7, further comprising:
at least one of a first reference block disposed around the first reference surface to abut a side surface of the first flange portion, and a second reference block disposed around the second reference surface to abut a side surface of the second flange portion;
wherein the front frame is positioned relative to the main frame in the X-axis direction by abutting the side surface of the first flange portion against the first reference block or abutting the side surface of the second flange portion against the second reference block.

9. The horizontal machine tool according to claim 3, further comprising:
an inclined plate disposed between the pair of the box-shaped pedestals, the inclined plate having a discharge port at a center in a left-right direction.

10. The horizontal machine tool according to claim 2, further comprising:
a pair of the connection blocks;
wherein the pair of the connection blocks are disposed on the main frame at a predetermined interval in the X-axis direction.

11. The horizontal machine tool according to claim 3, further comprising:
a pair of the connection blocks;
wherein the pair of the connection blocks are disposed on the main frame at a predetermined interval in the X-axis direction.

12. The horizontal machine tool according to claim 4, further comprising:
a pair of the connection blocks;
wherein the pair of the connection blocks are disposed on the main frame at a predetermined interval in the X-axis direction.

13. The horizontal machine tool according to claim 2, wherein
the connection block includes
a body portion,
a first flange portion disposed on a first end side of the body portion to be connected to the main frame, and
a second flange portion disposed on a second end side of the body portion to be connected to the front frame, and
the first flange portion and the second flange portion each have a flat end surface.

14. The horizontal machine tool according to claim 3, wherein
the connection block includes
a body portion,
a first flange portion disposed on a first end side of the body portion to be connected to the main frame, and
a second flange portion disposed on a second end side of the body portion to be connected to the front frame, and
the first flange portion and the second flange portion each have a flat end surface.

15. The horizontal machine tool according to claim 4, wherein
the connection block includes
a body portion,
a first flange portion disposed on a first end side of the body portion to be connected to the main frame, and
a second flange portion disposed on a second end side of the body portion to be connected to the front frame, and
the first flange portion and the second flange portion each have a flat end surface.

16. The horizontal machine tool according to claim 5, wherein
the connection block includes
a body portion,
a first flange portion disposed on a first end side of the body portion to be connected to the main frame, and
a second flange portion disposed on a second end side of the body portion to be connected to the front frame, and
the first flange portion and the second flange portion each have a flat end surface.
